(19) United States
(12) Patent Application Publication
(10) Pub. No.: US 2021/0243186 A1
(43) Pub. Date: Aug. 5, 2021

(54) SYSTEMS AND METHODS FOR PROVIDING DATA ACCESS BASED ON PHYSICAL PROXIMITY TO DEVICE

(71) Applicant: Acronis International GmbH, Schaffhausen (CH)

(72) Inventors: Alexander Tormasov, Moscow (RU); Serguei Beloussov, Costa Del Sol (SG); Stanislav Protasov, Moscow (RU)

(21) Appl. No.: 17/111,588

(22) Filed: Dec. 4, 2020

Related U.S. Application Data
(60) Provisional application No. 62/969,765, filed on Feb. 4, 2020.

(51) Int. Cl. H04L 29/06

(52) U.S. Cl. CPC H04L 63/0861; H04L 63/102; H04L 63/0435; H04L 63/0492

(57) ABSTRACT

Disclosed herein are systems and method for providing data access based on physical proximity between a user and a device. In one aspect, the method may comprise receiving, at the device, a request to access protected data, wherein the request comprises an authentication key for accessing the protected data. In response to verifying both that the authentication key is valid and that the device is being accessed by a proximate user based on the initial biometrics data, the method may comprise retrieving a presence profile that comprises historic biometric attributes of the authorized user. Simultaneous to collecting new biometric attributes of the proximate user, the method may comprise generating and comparing the temporary presence profile with the presence profile of the authorized user. While the temporary presence profile matches the presence profile, the method may comprise enabling access to the protected data.

### CROSS-REFERENCE TO RELATED APPLICATIONS

This application claims the benefit of U.S. Provisional Application No. 62/969,765, filed Feb. 4, 2020, which is herein incorporated by reference.

### FIELD OF TECHNOLOGY

The present disclosure relates to the field of data security, and, more specifically, to systems and methods for providing data access based on physical proximity between a user and a device.

### BACKGROUND

Conventional security systems often rely on rudimentary authentication procedures (e.g., a typed password, a fingerprint, a face match, etc.) to provide access to protected data. In some cases, there may be two-step authentication in which the user confirms his/her identity using a verification code emailed or texted to a trusted device registered in the security system. However, in either case, the authentication can be easily forged. For example, a hacker may gain access to protected data on a device by providing a password to the system (e.g., using brute-force login). If the security system sends a verification code, the hacker may intercept the code on the trusted device/email account and ultimately gain access to the protected data. The hacker does not need to be physically present to access the device and can potentially cause major damage remotely. Thus, there exists a need for a robust way of authenticating a user and preventing remote attacks.

### SUMMARY

To address these issues, aspects of the disclosure describe methods and systems for providing data access based on physical proximity between a user and a device. In an exemplary aspect, a method may comprise receiving initial biometrics data from a plurality of sensors connected to the device. The method may comprise receiving, at the device, a request to access protected data, wherein the request comprises an authentication key for accessing the protected data. In response to verifying both that the authentication key is valid and that the device is being accessed by a proximate user based on the initial biometrics data, the method may comprise retrieving a presence profile of an authorized user of the device, wherein the presence profile comprises historic biometric attributes of the authorized user. The method may comprise generating a temporary presence profile of the proximate user by continuously collecting, via the plurality of sensors, new biometric attributes. Simultaneous to the collecting, the method may comprise comparing the temporary presence profile with the presence profile of the authorized user. While the temporary presence profile matches the presence profile, the method may comprise enabling access to the protected data, and when the temporary presence profile no longer matches the presence profile, the method may comprise disabling access to the protected data.

In some aspects, the comparing and the verifying occur locally at the device.

In some aspects, retrieving the presence profile comprises: parsing the initial biometrics data into biometric attributes, and selecting the presence profile from a plurality of presence profiles stored in a database in response to comparing the biometric attributes with the historic biometric attributes, and determining that the biometric attributes match the historic biometric attributes.

In some aspects, verifying that the authentication key is valid and that the device is being accessed further comprises determining whether the initial biometrics data was received prior to receiving the request to access the protected data by a predetermined threshold time.

In some aspects, in response to determining that the initial biometrics data was not received prior to receiving the request to access the protected data by the predetermined threshold time, the method may comprise disabling access to the protected data.

In some aspects, the presence profile is associated with a plurality of rules indicating whether a generated presence profile matches the presence profile.

In some aspects, the method may comprise determining that the temporary presence profile no longer matches the presence profile based on at least one of: (1) detecting that the device is no longer being accessed, (2) determining that a rule of the plurality of rules associated with the presence profile is violated, and (3) detecting a disparity between a first set of the new biometric attributes collected at a first time and a second set of the new biometric attributes collected after the first time.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for providing data access based on physical proximity between a user and a device, in accordance with aspects of the present disclosure.

FIG. 2 is a diagram illustrating an example of generating a temporary profile and comparing the temporary profile with an existing presence profile, in accordance with aspects of the present disclosure.

FIG. 3 illustrates a flow diagram of a method for providing data access based on physical proximity between a user and a device, in accordance with aspects of the present disclosure.

FIG. 4 presents an example of a general-purpose computer system on which aspects of the present disclosure can be implemented.

### DETAILED DESCRIPTION

Exemplary aspects are described herein in the context of a system, method, and computer program product for providing data access based on physical proximity between a user and a device. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In order to prevent hackers from accessing protected data using basic forged authentication keys, the present disclosure describes a second authentication factor—proximity between an authorized user and a device. If an authorized user is present during an attempt to access or, if the authorized user himself/herself is attempting to access the protected data, the data should be made accessible.

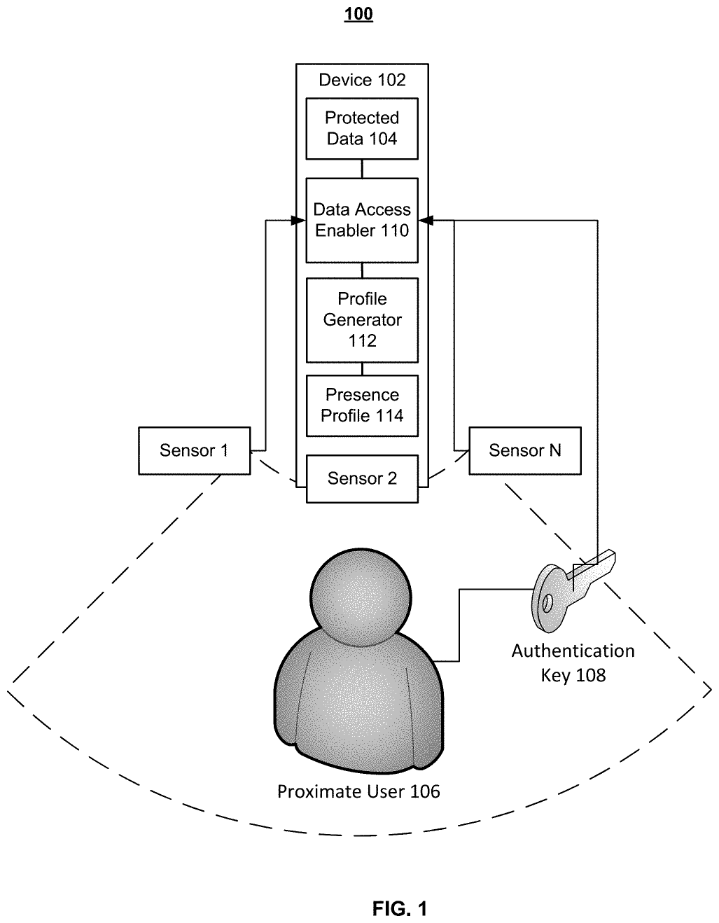

FIG. 1 is a block diagram illustrating system 100 for providing data access based on physical proximity between a user and a device, in accordance with aspects of the present disclosure. System 100 comprises device 102 that can provide access to protected data 104. Protected data 104 may be any data that is solely accessible to users that can provide authentication keys (e.g., decryption keys). Examples of protected data 104 include user documents, media files, application files, system configurations, etc. Device 102 may be any electronic device on which data can be accessed. Examples of device 102 include a server, a smartphone, a tablet, a computer, a smart TV, a smart speaker, etc.

Device 102 may be connected to a plurality of sensors such as sensor 1 and sensor N. In some aspects, a subset of the plurality of sensors may be embedded in device 102 (e.g., as an internal component) such as sensor 2. Sensors 1-N may be devices that can capture biometric data such as fingerprints, heart rate, heat map, facial image, etc. Examples of sensors 1-N may include an infrared sensor, a motion detector, a camera, a heart rate monitor, a fingerprint scanner, a smartwatch, etc. In some aspects, sensors 1-N are within a first threshold distance (e.g., 5 feet) from device 102 and can collect biometric data of objects within a second threshold distance (e.g., 3 feet) from themselves. The second threshold distance may be a radius of a virtual sphere within which a user may reside when accessing the device.

Sensors 1-N may continuously collect biometric data. When no user is accessing device 102, this biometric data may indicate inactivity. For example, a heart rate monitor will indicate that there is no heart rate (0 beats per minute). Data access enabler 110, which may be a module of a data security software, may analyze the raw data collected by the plurality of sensors and determine whether there is a proximate user in the vicinity of device 102. Data access enable 110 may also receive a request to access protected data 104. The request may be accompanied by authentication key 108 for accessing protected data 104. For example, protected data 104 may be a user profile on an operating system of device 102 and authentication key 108 may be a typed password or a fingerprint.

Data access enabler 110 may specifically verify both whether the authentication key is valid and whether there is a proximate user 106 accessing device 102. In some aspects, this verification is performed locally. Proximate user 106 may be a user that is in the vicinity of device 102 (e.g., within the range of sensors 1-N such that the biometric data of proximate user 106 is detectable). In some aspects, data access enabler 110 may determine whether a proximate user 106 is within the vicinity of the device 102 based on the type of device 102. For example, a proximate user 106 may be considered to be in the vicinity of a smart television if the distance between the user 106 and the smart television is at a maximum 5 feet. In contrast, if device 102 is a smart phone, the maximum distance may only be 1 foot.

It is important to ensure that authentication key 108, even if valid, is received from a proximate user 106 because authentication key 108 may be forgeable by a remote hacker. The additional biometrics data of proximate user 106 are needed as the second level of verification. Thus, in response to determining that authentication key 108 is valid and that proximate user 106 is accessing device 102, data access enabler 110 may retrieve presence profile 114. Presence profile 114 may comprise historic biometric attributes of an authorized user of device 102. Historic biometric attributes are parsed data points indicating characteristics of the authorized user. Each sensor of the plurality of sensors may provide raw data (e.g., images) that is parsed by profile generator 112 into a respective attribute (e.g., a classified face). Attributes may include a fingerprint, a face, a vocal pattern, a particular heat map, etc.

Data access enabler 110 may further instruct profile generator 112 to generate a temporary presence profile of proximate user 106. In response to the instruction, profile generator 112 creates the temporary presence profile, collects new biometrics data from sensors 1-N, parses the new biometrics data into new biometric attributes, and adds the new biometric attributes to the temporary presence profile.

Simultaneous to profile generator 112 collecting data and updating the temporary presence profile, data access enabler 110 compares the temporary presence profile with presence profile 114 (e.g., compare the respective attributes in each profile). In response to determining that the respective profiles match, data access enable 110 enables proximate user 106 to access protected data 104. However, if the respective profiles do not match or stop matching, data access enabler 110 disables the access to protected data 104.

The comparison of the respective profiles thus provides two-stage authentication/verification. The first stage involves a strong biometric authentication in the beginning of the process and/or periodical re-authentication (e.g., using DNA check, retinal scan, 3D face, etc.). The second stage is continuous proximity estimation during a session of access using the plurality of sensors such as IR/heat detectors, spectral video camera, Wi-Fi scanner, a radar/LIDAR, a scent/air odor analyzer, etc. Data access enabler 110 may specifically assess whether a user is within a threshold distance from device 102 and whether the user is indeed an authorized user of device 102. In some aspects, the analysis of raw biometrics data may be performed locally on device 102 to make it more difficult to intercept or forge the authentication inputs. This prevents access to the protected data 104 from suspicious remote parties over the Internet.

In some aspects, verifying that authentication key 108 is valid and that device 102 is being accessed by an authorized user further depends on determining whether the initial biometrics data was received prior to receiving the request to access the protected data by a predetermined threshold time (e.g., 30 seconds). This is a security check that ensures that even if a remote hacker attempts to send a request to a device 102 prior to its use by an authorized user, the request is not granted when the authorized user begins to use device 102. In other words, requests that are received before an authorized user begins accessing device 102 (which were intended to activate when the user unlocks device 102), are discarded. Thus, in response to determining that the initial biometrics data was not received prior to receiving the request to access the protected data by the predetermined threshold time, data access enabler 110 disables access to the protected data.

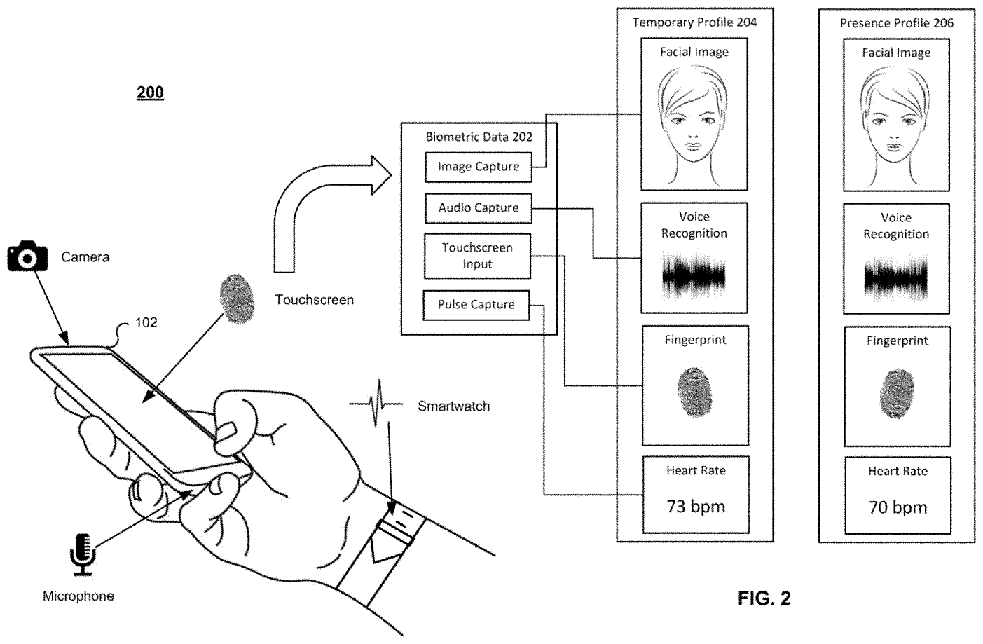

FIG. 2 is a diagram illustrating example 100 of generating a temporary profile and comparing the temporary profile with an existing presence profile, in accordance with aspects of the present disclosure. In example 200, a user may be using a smartphone that is connected to a smartwatch being worn by a user. As shown, there are at least four sensors that can be used to generate a temporary profile of the user of the smartphone. These sensors include a front-facing camera, a touchscreen, a microphone, and a smartwatch pulse detector. The raw information that the sensors collectively provide is comprised in biometric data 204. Namely, the camera captures visual images, the microphone captures audio, the touchscreen captures physical inputs (e.g., presses), and the pulse detector captures pulse data. Profile generator 112 on the smartphone (or a server connected to the smartphone via a network such as the Internet), may generate temporary profile 206 by parsing the visual image(s) to produce a facial image, the audio clip(s) to produce a vocal clip, the touchscreen input(s) to produce a fingerprint, and the pulse data to produce a heart rate. These biometric attributes are stored in temporary profile 204 for comparison with presence profile 206.

In FIG. 2, presence profile 206 comprises four attributes that can be compared with the four attributes in temporary profile 204. As can be seen, the attributes are not exact matches. For example, the facial images do not match exactly (the user changed her hairstyle), the fingerprints may partially match depending on the positioning of the user's fingers, the voices may share the same similar albeit not exact temporal and frequency characteristics, and the heart rate may differ by a few beats per minute (bpm).

In some aspects, data access enabler 110 may determine that two profiles correspond/match if at least a threshold number of attributes in the two profiles correspond within a threshold amount. For example, two heart rates may be considered as matching if they are within 5 bpm from each other. In another example, two facial images may be considered as matching if at least X amount of keypoints (e.g., around the curvature of the eyes, nose, etc.) match from a total amount of keypoints N.

These threshold values are preset, adjustable, and are stored in a plurality of rules associated with a presence profile. Rules are specific to each presence profile on a device (i.e., a device may have multiple users, each with their own presence profiles). For example, a first presence profile of a first user may have a rule that considers two heart rates as matching if they are within 5 bpm. A second presence profile of a second user may have a rule that considers two heart rates as matching if they are within 2 bpm. And yet another presence profile may include a rule that determines two hearts as matching if the average difference between the heart rates over a period of time is less than 3 bpm. These rules are also applicable to other attributes. Data access enabler 110 may first evaluate each individual attribute (to see if they match) using these rules as guidance and then determine the number of matching attributes to make a conclusion on whether two profiles match.

For each user of a device, multiple presence profiles may be generated and stored. This accounts for physical changes the user may undergo over time. For example, a presence profile may be generated when the user first uses device 102. After a week, another presence profile may be generated in which the user's hairstyle has slightly changed. After two weeks, yet another presence profile may be generated by profile generator 112. Determining whether to keep a presence profile may be based on comparing the new presence profile with the direct-previously created presence profile. Thus, if a user has made a significant change over a year such that the first presence profile does not correspond with the new presence profile, the new presence profile will still be saved because the plurality of presence profiles made over the year account for the iterative changes the user has gone through.

In some aspects, data access enabler 110 may perform the comparison between the temporary presence profile and presence profile 114 using a machine learning algorithm configured to classify whether the respective profiles match. In some aspects, the machine learning algorithm may provide a confidence level on the likelihood of a match.

In some aspects, the machine learning algorithm may be configured to identify unique data (i.e., data that is particular to the authorized user) and attempt to detect the unique data in the temporary presence profile. The use of unique data enables the exclusion of any accidental manifestations associated with the momentary physical state of a person, mood, illness, etc., of a proximate user 106 that is not actually authorized to access protected data 104.

In some aspects, the machine learning algorithm may monitor different trends in presence profile 114 and may check whether the trends are found in the temporary presence profile. For example, the heart rate of an authorized user may follow a certain pattern that frequently appears in the historic biometric attributes of presence profile 114. The machine learning algorithm may detect this trend in heart rate and assess whether a similar trend is found in the temporary presence profile.

In some aspects, the machine learning algorithm may use approximations when performing the comparison between the respective profiles. For example, the machine learning algorithm may use fuzzy matching where the fuzzy hashes of the temporary presence profile and presence profile 114 are compared.

In some aspects, the machine learning algorithm is a one-class support vector machine (SVM) that classifies whether a temporary presence profile matches a known presence profile. The one-class SVM enables the training dataset to be small (e.g., a single reading from each sensor) that can be used to compare with later-generated temporary presence profile. For example, the training dataset may be a generated by acquiring biometric information from the plurality of sensors when the user first uses the device (e.g., subsequent to buying the device and using it for the first time). This acquisition of biometric information may last for a period of time (e.g., 5 minutes) over which all readings are averaged. For example, over 5 minutes, a heart rate monitor may take 100 readings and determine the average heart rate of the user. Likewise, a camera may acquire facial images of the user and then determine an average facial image. The average values may be stored in a data structure (e.g., an array) that can be used as the training input for the one-class SVM. Subsequently all input vectors can be fed into the one-class SVM, which determines whether a match exists.

In some aspects, data access enabler 110 may detect that after a period of time, the temporary presence profile and presence profile 114 have stopped matching. This may happen if, for example, data access enabler 110 detects that device 102 is no longer being accessed, or if data access enabler 110 determines that a rule of the plurality of rules associated with presence profile 114 is violated, or if data access enabler 110 detects a disparity between a first set of the new biometric attributes collected at a first time and a second set of the new biometric attributes collected after the first time.

In response to the detection of non-match, data access enabler 110 may detect all portions of the temporary presence profile that have matched and store them as a part of presence profile 114. To offer more robust storage, in some aspects, the biometric attributes are stored in an external blockchain storages accessible via a network such as the Internet. This decreases the memory burden on device 102 while still keeping the presence profile secure.

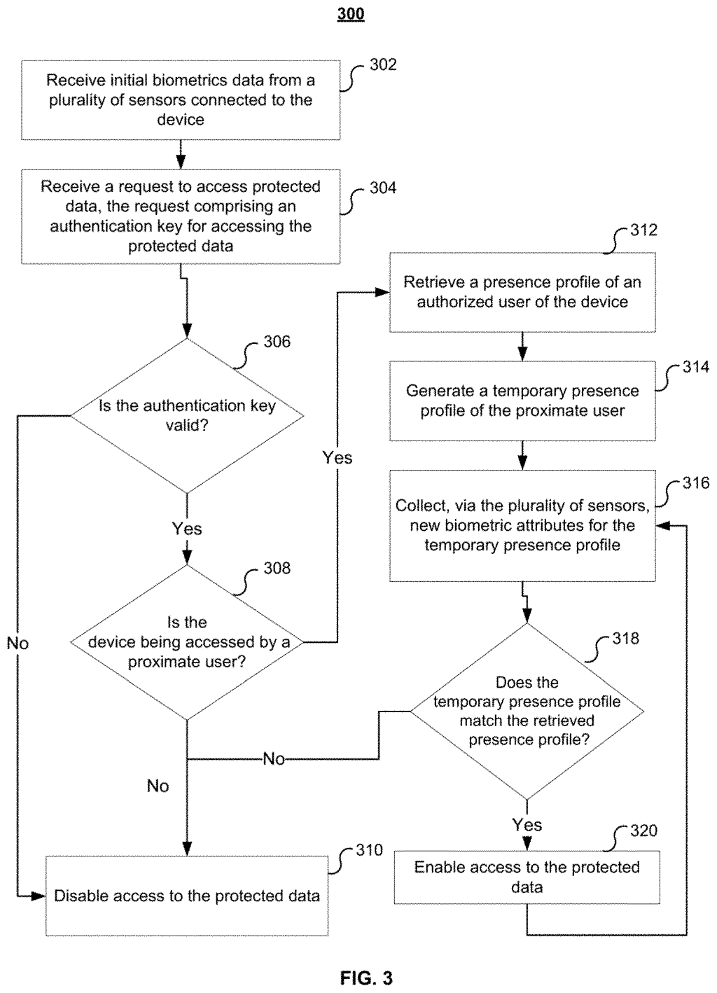

FIG. 3 illustrates a flow diagram of method 300 for providing data access based on physical proximity between a user and a device, in accordance with aspects of the present disclosure. At 302, data access enabler 110 receives initial biometrics data from a plurality of sensors (e.g., sensors 1-N) connected to device 102. At 304, data access enabler 110 receives a request to access protected data 104, the request comprising an authentication key 108 for accessing the protected data 104. At 306, data access enabler 110 verifies whether the authentication key 108 is valid. In response to determining that the key 108 is valid, at 308, data access enabler 110 determines whether device 102 is being accessed by a proximate user 106. If data access enabler 110 determines that neither the key 108 is valid and the device is being accessed by a proximate user 106, method 300 ends at 310, where data access enabler 110 disables access to the protected data 104.

However, if data access enabler 110 verifies both that the key 108 is valid at 306 and that the device 102 is being accessed by a proximate user 106 at 308, method 300 advances to 312, where data access enabler 110 retrieves a presence profile 114 of an authorized user of the device 102. At 314, profile generator 112 generates a temporary presence profile of the proximate user 106. At 316, data access enabler 110 populates the temporary presence profile by collecting, via the plurality of sensors, new biometric attributes for the temporary presence profile. At 318, data access enabler 110 determines whether the temporary presence profile matches the retrieved presence profile 114. In response to determining that the respective profiles match, at 320, data access enabler 110 enables access to the protected data 104. From 320, method 300 returns to 316 where additional biometric attributes are collected and analyzed. The loop between 316 and 320 continues until the respective presence profiles no longer match. This may occur when, for example, the proximate user 106 moves away from the device 102 (e.g., to cease access) and the data collected for the temporary presence profile does not match the retrieve presence profile 114 as there is no longer biometrics data being acquired for a human.

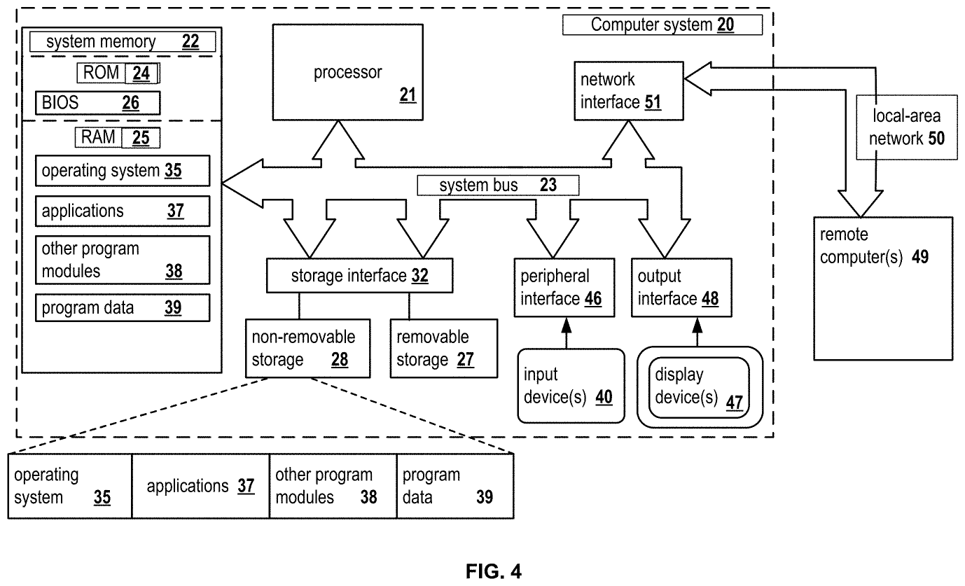

FIG. 4 is a block diagram illustrating a computer system 20 on which aspects of systems and methods for providing data access based on physical proximity between a user and a device may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-2 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for providing data access based on physical proximity between a user and a device, the method comprising:
receiving initial biometrics data from a plurality of sensors connected to the device;
receiving, at the device, a request to access protected data, wherein the request comprises an authentication key for accessing the protected data;
in response to verifying both that the authentication key is valid and that the device is being accessed by a proximate user based on the initial biometrics data, retrieving a presence profile of an authorized user of the device, wherein the presence profile comprises historic biometric attributes of the authorized user;
generating a temporary presence profile of the proximate user by continuously collecting, via the plurality of sensors, new biometric attributes;
simultaneous to the collecting, comparing the temporary presence profile with the presence profile of the authorized user;
while the temporary presence profile matches the presence profile, enabling access to the protected data; and
when the temporary presence profile no longer matches the presence profile, disabling access to the protected data.

2. The method of claim 1, wherein the comparing and the verifying occur locally at the device.

3. The method of claim 1, wherein retrieving the presence profile comprises:
parsing the initial biometrics data into biometric attributes;
selecting the presence profile from a plurality of presence profiles stored in a database in response to:
comparing the biometric attributes with the historic biometric attributes; and
determining that the biometric attributes match the historic biometric attributes.

4. The method of claim 1, wherein verifying that the authentication key is valid and that the device is being accessed further comprises determining whether the initial biometrics data was received prior to receiving the request to access the protected data by a predetermined threshold time.

5. The method of claim 4, further comprising:
in response to determining that the initial biometrics data was not received prior to receiving the request to access the protected data by the predetermined threshold time, disabling access to the protected data.

6. The method of claim 1, wherein the presence profile is associated with a plurality of rules indicating whether a generated presence profile matches the presence profile.

7. The method of claim 6, further comprising:
determining that the temporary presence profile no longer matches the presence profile based on at least one of:
(1) detecting that the device is no longer being accessed;
(2) determining that a rule of the plurality of rules associated with the presence profile is violated; and
(3) detecting a disparity between a first set of the new biometric attributes collected at a first time and a second set of the new biometric attributes collected after the first time.

8. A system for providing data access based on physical proximity between a user and a device, the system comprising:
a hardware processor configured to:
receive initial biometrics data from a plurality of sensors connected to the device;
receive a request to access protected data, wherein the request comprises an authentication key for accessing the protected data;
in response to verifying both that the authentication key is valid and that the device is being accessed by a proximate user based on the initial biometrics data, retrieve a presence profile of an authorized user of the device, wherein the presence profile comprises historic biometric attributes of the authorized user;
generate a temporary presence profile of the proximate user by continuously collecting, via the plurality of sensors, new biometric attributes;
simultaneous to the collecting, compare the temporary presence profile with the presence profile of the authorized user;
while the temporary presence profile matches the presence profile, enable access to the protected data; and
when the temporary presence profile no longer matches the presence profile, disable access to the protected data.

9. The system of claim 8, wherein the comparing and the verifying occur locally at the device.

10. The system of claim 8, wherein the hardware processor is configured to retrieve the presence profile by:
parsing the initial biometrics data into biometric attributes;
selecting the presence profile from a plurality of presence profiles stored in a database in response to:
comparing the biometric attributes with the historic biometric attributes; and
determining that the biometric attributes match the historic biometric attributes.

11. The system of claim 8, wherein the hardware processor is configured to verify that the authentication key is valid and that the device is being accessed by determining whether the initial biometrics data was received prior to receiving the request to access the protected data by a predetermined threshold time.

12. The system of claim 11, wherein in response to determining that the initial biometrics data was not received prior to receiving the request to access the protected data by the predetermined threshold time, the hardware processor is configured to disable access to the protected data.

13. The system of claim 8, wherein the presence profile is associated with a plurality of rules indicating whether a generated presence profile matches the presence profile.

14. The system of claim 13, wherein the hardware processor is further configured to:
determine that the temporary presence profile no longer matches the presence profile based on at least one of:
(1) etecting that the device is no longer being accessed;
(2) determining that a rule of the plurality of rules associated with the presence profile is violated; and
(3) detecting a disparity between a first set of the new biometric attributes collected at a first time and a second set of the new biometric attributes collected after the first time.

15. A non-transitory computer readable medium storing thereon computer executable instructions for providing data access based on physical proximity between a user and a device, including instructions for:
receiving initial biometrics data from a plurality of sensors connected to the device;
receiving, at the device, a request to access protected data, wherein the request comprises an authentication key for accessing the protected data;
in response to verifying both that the authentication key is valid and that the device is being accessed by a proximate user based on the initial biometrics data, retrieving a presence profile of an authorized user of the device, wherein the presence profile comprises historic biometric attributes of the authorized user;
generating a temporary presence profile of the proximate user by continuously collecting, via the plurality of sensors, new biometric attributes;
simultaneous to the collecting, comparing the temporary presence profile with the presence profile of the authorized user;
while the temporary presence profile matches the presence profile, enabling access to the protected data; and
when the temporary presence profile no longer matches the presence profile, disabling access to the protected data.

16. The non-transitory computer readable medium of claim 15, wherein the comparing and the verifying occur locally at the device.

17. The non-transitory computer readable medium of claim 15, wherein an instruction for retrieving the presence profile comprises further instructions for:
parsing the initial biometrics data into biometric attributes;
selecting the presence profile from a plurality of presence profiles stored in a database in response to:
comparing the biometric attributes with the historic biometric attributes; and
determining that the biometric attributes match the historic biometric attributes.

18. The non-transitory computer readable medium of claim 15, wherein an instruction for verifying that the authentication key is valid and that the device is being accessed further comprises instructions for determining whether the initial biometrics data was received prior to receiving the request to access the protected data by a predetermined threshold time.

19. The non-transitory computer readable medium of claim 18, further comprising instructions for:
in response to determining that the initial biometrics data was not received prior to receiving the request to access the protected data by the predetermined threshold time, disabling access to the protected data.

20. The non-transitory computer readable medium of claim 15, wherein the presence profile is associated with a plurality of rules indicating whether a generated presence profile matches the presence profile.
